(19) United States
(12) Patent Application Publication
(10) Pub. No.: US 2017/0028995 A1
(43) Pub. Date: Feb. 2, 2017

(54) VEHICLE CONTROL APPARATUS

(71) Applicant: TOYOTA JIDOSHA KABUSHIKI KAISHA, Toyota-shi (JP)

(72) Inventors: Hiroki MORI, Susono-shi (JP); Ryuji FUNAYAMA, Yokohama-shi (JP); Jun SATO, Susono-shi (JP); Ayako SHIMIZU, Numazu-shi (JP); Yuichi KUMAI, Gotenba-shi (JP); Yuma KAWAMORI, Susono-shi (JP); Takeshi MATSUMURA, Numazu-shi (JP); Yasuo SAKAGUCHI, Nagakute-shi (JP); Tsukasa SHIMIZU, Nagakute-shi (JP)

(73) Assignee: TOYOTA JIDOSHA KABUSHIKI KAISHA, Toyota-shi (JP)

(21) Appl. No.: 15/180,240

(22) Filed: Jun. 13, 2016

(30) Foreign Application Priority Data
Jul. 31, 2015 (JP) 2015-152563

(51) Int. Cl. B60W 50/08; B60K 35/00; G06K 9/00; G05D 1/00

(52) U.S. Cl. CPC B60W 50/082; G05D 1/0088; B60K 35/00; G06K 9/00798

(57) ABSTRACT

A vehicle control apparatus includes a lane recognition unit configured to recognize a travel lane, a travel control unit configured to control the travelling of the vehicle such that the driving state of the vehicle becomes autonomous driving, a system margin time estimation unit configured to estimate a system margin time which is a time taken for the control of the travelling of the vehicle by the travel control unit to stop, a hand-over time estimation unit configured to estimate a hand-over time which is a time for a driver to be able to return the driving state to manual driving, and an HMI control unit configured to display the system margin time and the hand-over time on a display unit.

### TECHNICAL FIELD

The present invention relates to a vehicle control apparatus.

### BACKGROUND

There is a vehicle control apparatus that autonomously controls travelling of a vehicle such as controlling the vehicle such that it travels along a travel lane. Such a vehicle control apparatus that autonomously controls travelling of a vehicle is disclosed in, for example, Japanese Unexamined Patent Publication No. 2011-73529.

### SUMMARY

Here, in a vehicle control apparatus that autonomously controls travelling of a vehicle, many driving operations subject to be originally performed by a driver are autonomously performed by a vehicle control apparatus. Therefore, it is considered that a driver's awareness for the driving operation may decrease. In a case where the driver's awareness for the driving operation decreases, it is considered that a hand-over time may increase, which is a time taken for the driver to return the driving state to manual driving from an autonomous driving state in which the vehicle is autonomously driven. In addition, in the vehicle control apparatus that autonomously controls the travelling of the vehicle, there may be a case where the control of the travelling of the vehicle is stopped depending on an accuracy of detecting lane lines on a road. Therefore, it is preferable that a state is maintained, in which the hand-over time is shorter than a system margin time which is a time taken for the control of the travelling of the vehicle to stop. In order to realize this, it is desirable that the driver can recognize the system margin time and hand-over time.

Therefore, an aspect of the present invention has an object to provide a vehicle control apparatus in which the driver can recognize the system margin time and the hand-over time.

According to an aspect of the present invention, a vehicle control apparatus configured to be mounted on a vehicle in which a driving state can be switched between autonomous driving and manual driving is provided. The apparatus includes a lane recognition unit configured to detect lane lines on a road on which the vehicle travels based on image information from a camera and to recognize a travel lane of the vehicle based on a result of detecting the lane lines; a travel control unit configured to control the travelling of the vehicle such that the driving state of the vehicle becomes autonomous driving based on the travel lane recognized by the lane recognition unit; a first estimation unit configured to estimate a system margin time which is a time taken for the control of the travelling of the vehicle by the travel control unit to stop, based on the accuracy of detecting the lane lines by the lane recognition unit; a second estimation unit configured to estimate a hand-over time which is a time taken for the driving state of the vehicle to return to manual driving by the driver from the autonomous driving state, based on a state of the driver of the vehicle; and a display control unit configured to display the system margin time and the hand-over time on a display unit.

In the vehicle control apparatus, the first estimation unit estimates the system margin time based on the accuracy of detecting the lane lines by the lane recognition unit. The second estimation unit estimates the hand-over time based on the state of the driver of the vehicle. The display control unit displays the system margin time and the hand-over time on the display unit. In this way, the driver of the vehicle can recognize the system margin time and the hand-over time. As described above, by the driver recognizing the system margin time and the hand-over time, it is possible for the driver to maintain the awareness for the driving operation such as being aware of shortening the hand-over time.

According to an aspect of the present invention, the driver can recognize the system margin time and hand-over time.

### BRIEF DESCRIPTION OF THE DRAWINGS

FIG. 1 is a block diagram illustrating a schematic configuration of a vehicle control apparatus in an embodiment.

FIG. 2A to FIG. 2C are examples of displays for illustrating the system margin time in bar graphs and illustrating the hand-over time by heights of crossbars.

FIG. 3A to FIG. 3C are examples of displays for illustrating the system margin time and the hand-over time by line graphs.

FIG. 4A to FIG. 4C are examples of displays for illustrating the system margin time and the hand-over time at position points P on 2D maps.

FIG. 5 is a flowchart illustrating flows of processing that displays the system margin time and the hand-over time and processing that performs a warning display or the like.

### DETAILED DESCRIPTION

Hereinafter, an embodiment of the present invention will be described with reference to the drawings. In describing the drawings, the same reference signs will be given to the same elements and the descriptions thereof will be omitted.

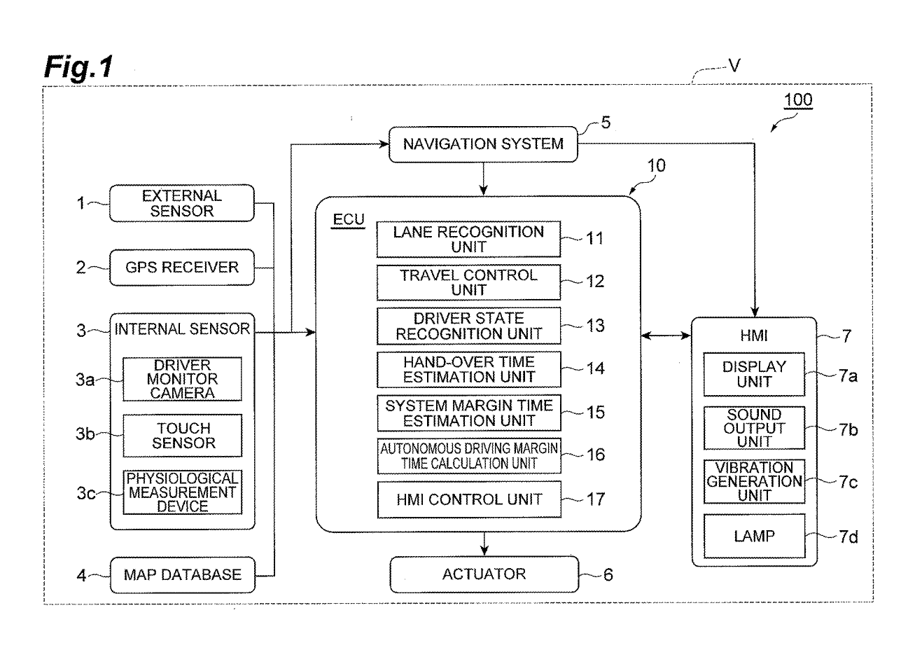

FIG. 1 is a block diagram illustrating a schematic configuration of a vehicle control apparatus 100. The vehicle control apparatus 100 illustrated in FIG. 1 is mounted on a vehicle such as a passenger car and controls travelling of the vehicle. The vehicle control apparatus 100 performs an autonomous driving to cause the vehicle to autonomously travel.

Here, the autonomous driving is a driving to cause a vehicle to autonomously travel toward a destination set in advance. Alternatively, even in a state in which the destination is not set in advance, the autonomous driving may be a driving to cause a vehicle to autonomously travel such that a lane in which the vehicle currently travels is kept while considering a state of other surrounding vehicles. In addition, the autonomous driving means a driving of the vehicle performed mainly by the vehicle control apparatus 100. The autonomous driving may be a complete autonomous driving in which the driver of the vehicle is not involved in driving. In addition, the autonomous driving may be a driving by a driving assistance control such as a driving performed mainly by the vehicle control apparatus 100 while receiving a support from the driver of the vehicle.

The vehicle control apparatus 100 can switch a driving state of the vehicle from the autonomous driving to the manual driving and vice versa. The manual driving means a driving of the vehicle mainly performed by the driver. The manual driving may be a driving to cause the vehicle to travel based on only, for example, the driver's driving operation. In addition, the manual driving may be a driving in which a part of adjustment of steering and speed of the vehicle is controlled by the vehicle control apparatus 100 as long as the driving operation is in the driving state of being mainly performed by the driver.

The vehicle control apparatus 100 starts the autonomous driving in a case where the driver performs an operation for starting the autonomous driving. The operation for starting the autonomous driving is an operation of pushing an autonomous driving start switch provided on, for example, a steering wheel. The vehicle control apparatus 100 releases the autonomous driving in a case where the driver performs an operation for releasing the autonomous driving. In this way, the driving state of the vehicle is switched from the autonomous driving to the manual driving. The operation for releasing the autonomous driving is an operation of pushing an autonomous driving cancel switch provided on, for example, the steering wheel. In addition, the vehicle control apparatus 100 may release the autonomous driving in a case where the driving operation of which the amount of operation exceeds an allowable amount of autonomous driving operation set in advance such as a case where the driver performs a rapid braking operation during the autonomous driving.

Next, details of the vehicle control apparatus 100 will be described. As illustrated in FIG. 1, the vehicle control apparatus 100 includes an external sensor 1, a global positioning system (GPS) receiver 2, an internal sensor 3, a map database 4, a navigation system 5, an actuator 6, a human machine interface (HMI) 7, and an electronic control unit (ECU) 10.

The external sensor 1 is a detection device that detects an external situation around a vehicle V. The external sensor 1 includes a camera. The external sensor 1 further includes at least any of radar and a laser imaging detection and ranging (LIDAR).

The camera is an imaging device that images the surroundings of the vehicle V. The camera is provided, for example, in the cabin side of a windshield of the vehicle V. The camera transmits the captured image information to the ECU 10. The radar detects an obstacle outside of the vehicle V using a radio wave (for example, a millimeter wave). The radar detects the obstacle by transmitting the radio wave to the surroundings of the vehicle V and receiving the radio wave reflected from the obstacle. The radar transmits the detected obstacle information to the ECU 10. The LIDAR detects the obstacle outside the vehicle V using light. The LIDAR transmits the light to the surroundings of the vehicle V, measures the distance to the reflection point by receiving the light reflected from the obstacle, and then, detects the obstacle. The LIDAR transmits the detected obstacle information to the ECU 10.

The GPS receiver 2 receives signals from three or more GPS satellites and measures the position of the vehicle V (for example, the latitude and longitude of the vehicle V). The GPS receiver 2 transmits the measured position information of the vehicle V to the ECU 10. Instead of the GPS receiver 2, another means for specifying the latitude and the longitude of the vehicle V may be used.

The internal sensor 3 is a detection device that detects the travelling state of the vehicle V and a state of the driver. The internal sensor 3 includes a vehicle speed sensor, an acceleration sensor, and a yaw rate sensor. The vehicle speed sensor is a detection device that detects the speed of the vehicle V. As the vehicle speed sensor, for example, a wheel speed sensor is used, which detects a rotational speed of the vehicle wheels. The vehicle speed sensor transmits the detected vehicle speed information (vehicle wheel speed information) to the ECU 10. The acceleration sensor is a detection device that detects acceleration (acceleration and deceleration) of the vehicle V. The acceleration sensor transmits, for example, the acceleration information of the vehicle V to the ECU 10. The yaw rate sensor is a detection device that detects a yaw rate (rotational angular velocity) around the vertical axis of the center of gravity of the vehicle V. As the yaw rate sensor, for example, a gyro sensor can be used. The yaw rate sensor transmits the detected yaw rate information of the vehicle V to the ECU 10.

The internal sensor 3 further includes a driver monitor camera 3a, a touch sensor 3b, and a physiological measurement device 3c. The driver monitor camera 3a captures an image of the driver. The driver monitor camera 3a is provided, for example, on a cover of a steering column of the vehicle V and in front of the driver. A plurality of driver monitor cameras 3a may be provided in order to capture the images of the driver from a plurality of directions. The driver monitor camera 3a transmits the image information to the ECU 10.

The touch sensor 3b is provided, for example, on the steering wheel of the vehicle V. As the touch sensor 3b, for example, a pressure-sensitive sensor can be used. The touch sensor 3b detects a presence or absence of a driver's grip of the steering wheel. The touch sensor 3b transmits the detection result to the ECU 10. The physiological measurement device 3c detects a physiological state of the driver. The physiological measurement device 3c detects, for example, a pulse, brain waves, and body temperature as the physiological state of the driver. The physiological measurement device 3c may be a wearable device for the driver to wear. The physiological measurement device 3c transmits the detected physiological state to the ECU 10.

The map database 4 is a database in which map information is included. The map database is formed, for example, in a hard disk drive (HDD) mounted on the vehicle V. In the map information, for example, position information of roads, information on road shapes (for example, types of curves and straight portion, a curvature of the curve), and position information of intersections and branch points are included. The map information may be stored in a computer in a facility such as an information processing center which is capable of communicating with the vehicle V.

The navigation system 5 is a device that performs guidance for the driver of the vehicle V to a destination set by the driver of the vehicle V. The navigation system 5 calculates a target travelling route of the vehicle V based on the position information of the vehicle V measured by the GPS receiver 2 and the map information in the map database 4. The target route may be a route on which a preferable lane is specified in a road section of multi-lane.

The navigation system 5 calculates, for example, the target route from the position of the vehicle V to the destination and performs notification to the driver of the target route by displaying on a display or a voice output through a speaker. The navigation system 5 transmits the target route information of the vehicle V to the ECU 10. The navigation system 5 may be stored in a computer in a facility such as an information processing center which is capable of communicating with the vehicle V.

The actuator 6 is a device that controls the vehicle state of the vehicle V. The actuator 6 includes at least a throttle actuator, a brake actuator, and a steering actuator. The throttle actuator controls a supply amount (throttle opening degree) of air to an engine according to an instruction control value from the ECU 10, and controls the driving power of the vehicle V. In a case where the vehicle V is a hybrid vehicle or an electric vehicle, the throttle actuator is not included and the driving power is controlled by the instruction control value from the ECU 10 being input to a motor which is a source of the driving force.

The brake actuator controls a brake system according to the instruction control value from the ECU 10 and controls the braking power given to the wheels of the vehicle V. For example, a hydraulic brake system can be used as the brake system. The steering actuator controls the driving of an assist motor that controls steering torque in the electric power steering system according to the instruction control value from the ECU 10. In this way, the steering actuator controls the steering torque of the vehicle V.

The HMI 7 is an interface that performs input and output of information between occupants (including the driver) of the vehicle V and the vehicle control apparatus 100. The HMI 7 includes, for example, a display unit 7a, sound output unit 7b, vibration generation unit 7c, lamp 7d, and an operation button or a touch panel for the occupants to perform the input operation. The display unit 7a is a device for performing the visual notification to the driver. The display unit 7a displays the image information. The display unit 7a may be configured with a multiple kinds of displays. The display unit 7a includes, for example, at least one of a multi-information display (MID) of a combination meter, a center display of an instrument panel, a head-up display (HUD), and a glass type wearable display the driver wears. In addition, the display unit 7a may include a display of a driver's smart phone. The display unit 7a displays the image information according to the control signal from the ECU 10.

The sound output unit 7b is a device for performing an audio notification to the driver. The sound output unit 7b is speaker for performing the notification to the driver by outputting a voice or a signal sound. The sound output unit 7b may be configured with a plurality of speakers or may be configured to include a speaker provided in the vehicle V. The sound output unit 7b includes, for example, at least one of a speaker provided in the back side of the instrument panel of the vehicle V, a speaker provided inside of the door at the driver's seat of the vehicle V, and the like. In addition, the sound output unit 7b may include a speaker of the driver's smart phone. The sound output unit 7b outputs the voice or the signal sound to the driver according to the control signal from the ECU 10.

The vibration generation unit 7c is a device for performing a tactile notification to the driver. The vibration generation unit 7c generates vibrations. The vibration generation unit 7c includes, for example, a vibration motor. The vibration generation unit 7c is provided on, for example, at least any of a seat the driver sits on, an arm rest the driver uses, and the steering wheel. In addition, the vibration generation unit 7c may include a vibration generation unit included in the driver's smart phone.

The lamp 7d is a device for performing a visual notification to the driver. The lamp 7d is a lamp of which light can be switched to be ON and OFF or of which the colors can be changed. The lamp 7d is provided on a position visible from the driver such as on the instrument panel positioned in front of the driver. The lamp 7d switches the light to be ON and OFF or changes the colors according to the control signal from the ECU 10. The display unit 7a, the sound output unit 7b, the vibration generation unit 7c, and the lamp 7d may not necessarily configure a part of the HMI 7.

Next, a functional configuration of the ECU 10 will be described. The ECU 10 is an electronic control unit including a central processing unit (CPU), read only memory (ROM), random access memory (RAM), and the like. In the ECU 10, various controls are performed by loading the program stored in the ROM into the RAM and executing the program by the CPU. The ECU 10 may be configured with a plurality of electronic control units. A part of the functions of ECU 10 may be executed by a computer in a facility such as an information processing center which is capable of communicating with the vehicle V.

The ECU 10 includes a lane recognition unit 11, a travel control unit 12, a driver state recognition unit 13, a hand-over time estimation unit 14 (second estimation unit), a system margin time estimation unit 15 (first estimation unit), an autonomous driving margin time calculation unit 16, and an HMI control unit 17 (display control unit).

The lane recognition unit 11 detects lane lines on the road on which the vehicle V travels based on the image information from the camera of the external sensor 1. Then, the lane recognition unit 11 recognizes the travel lane of the vehicle V based on the detected lane lines. The detection of the lane lines and the recognition of the travel lane performed by the lane recognition unit 11 can be performed by a known method such as performing image processing on the image information.

In addition, the lane recognition unit 11 calculates the detection accuracy when detecting the lane lines. For example, in a case where many noises are included in the image (image information) captured by the camera, the lane recognition unit 11 calculates the detection accuracy to be lower than that in a case where the included noises are small. In a case where it is difficult to detect the lane lines because the lane lines included in the image information from the camera is blurred, the lane recognition unit 11 calculates the detection accuracy to be lower than that in a case where the lane lines are not blurred.

The travel control unit 12 controls the travelling of the vehicle V such that the driving state of the vehicle V becomes the autonomous driving based on the travel lane recognized by the lane recognition unit 11. Specifically, the travel control unit 12 generates a path of the vehicle V based on, for example, the target route calculated by the navigation system 5, the position information of the vehicle V acquired by the GPS receiver 2, and an external situation of the vehicle V. The external situation of the vehicle V can be recognized based on the result of detection (for example, the image information from the camera, the obstacle information from the radar, the obstacle information from the LIDAR, or the like) by the external sensor 1. In addition, the travel lane of the vehicle V recognized by the lane recognition unit 11 is included in the external situation of the vehicle V. The path is a trajectory in the travel lane in which the vehicle V travels along the target route.

In the target route described here includes a travel route which is automatically generated based on the external situation or the map information when the setting of the destination is not explicitly performed by the driver as in a case of a travel route along the road in the “driving assistance apparatus” disclosed in Japanese Patent No. 5382218 (WO 2011/158347) or the “autonomous driving apparatus” disclosed in Japanese Unexamined Patent Publication No. 2011-62132.

The travel control unit 12 generates a travel plan along the path based on at least the external situation of the vehicle V, the travelling state of the vehicle V recognized based on the result of detection by the internal sensor 3, and the map information in the map database 4. The travel control unit 12 outputs the generated travel plan as a plan having a plurality of combinations of two elements of a target position p on a coordinate system on which the path of the vehicle V is fixed to the vehicle V and a vehicle speed v at each target position, that is, a plurality of configuration coordinates (p, v). Each target position p has at least position of the x and y coordinates on the coordinate system fixed on the vehicle V or information equivalent thereto. The travel plan is not particularly limited as long as it indicates the behavior of the vehicle V.

The travel control unit 12 causes the vehicle V to perform autonomous driving based on the travel plan by the actuator 6 outputting the control signal according to the generated travel plan.

In addition, in the autonomous driving state of the vehicle V and in a case where the autonomous driving margin time calculated by the autonomous driving margin time calculation unit 16 is shorter than 0 (zero), the travel control unit 12 switches the driving state from the autonomous driving to the manual driving. The travel control unit 12 performs the switching of the driving state to the manual driving after the warning is displayed by the HMI control unit 17. Furthermore, in a case where the operation of releasing the autonomous driving is performed by the driver as described above, or in a case where the driving operation is performed, of which the amount of operation exceeds an allowable amount of operation for the autonomous driving set in advance, the travel control unit 12 may release the autonomous driving.

The driver state recognition unit 13 recognizes the state of the driver. The driver state recognition unit 13 recognizes the direction of the driver's line of sight, a driving posture of the driver, an awakening degree of the driver, and a degree of tiredness of the driver as the state of the driver.

Specifically, the driver state recognition unit 13 recognizes the direction of the driver's line of sight based on the image information from the driver monitor camera 3a. The line of sight can be recognized based on the direction of a face, the direction of pupils in the eyeballs. The driver state recognition unit 13 recognizes the driving posture of the driver based on the image information from the driver monitor camera 3a. Here, as the driving posture of the driver, the driver state recognition unit 13 recognizes, for example, a posture of the driver gripping the steering wheel, a posture of the driver poised to be able to depress the accelerator pedal or the brake pedal immediately, and a cross-legged posture. The driver state recognition unit 13 may recognize the posture of the driver gripping the steering wheel based on the result of detection by the touch sensor 3b.

The driver state recognition unit 13 recognizes the awakening degree of the driver based on the physiological state of the driver. As the physiological state of the driver, the driver state recognition unit 13 uses at least any of the result of detection by the physiological measurement device 3c and a blink of the driver obtained based on the image information from the driver monitor camera 3a. The driver state recognition unit 13 can calculate the awakening degree by a known method based on the result of detection by the physiological measurement device 3c and the blink of the driver. In a case where the driver is dozing or in a case where the driver is in a careless state, the awakening degree is low. On the other hand, in a case where the driver's consciousness is clear, the awakening degree is high.

The driver state recognition unit 13 recognizes the degree of tiredness of the driver based on a time elapsed from starting of the driving. In a case where the time elapsed from starting of the driving is long, the driver state recognition unit 13 recognizes that the degree of tiredness is higher than that in a case where the time elapsed from starting of the driving is short. The time elapsed from starting of the driving may be a time elapsed from the time when the driver boards the vehicle V and starts travelling this time. In addition, the time elapsed from starting of the driving may be a sum of the time in which the autonomous driving is performed by the travel control unit 12 from the time when the driver boards the vehicle V this time.

The hand-over time estimation unit 14 estimates the hand-over time based on the state of the driver recognized by the driver state recognition unit 13. The hand-over time is time taken for the driving state of the vehicle V to be able to return to the manual driving by the driver from the autonomous driving state (a time taken for the driving state of the vehicle V to be able to start the manual driving).

Specifically, the hand-over time estimation unit 14 estimates the hand-over time based on at least any of the direction of a driver's line of sight, the driving posture of the driver, the awakening degree of the driver, and the degree of tiredness of the driver recognized by the driver state recognition unit 13 as the states of the driver.

The case where the hand-over time estimation unit 14 estimates the hand-over time based on the direction of a driver's line of sight recognized by the driver state recognition unit 13 will be described. For example, in a case where the driver is facing toward the front direction of the vehicle V, the driving state can be returned to the manual driving within a shorter time than in a case where the driver is looking aside. Therefore, for example, in a case where the direction of the driver's line of sight is facing the front direction of the vehicle V, the hand-over time estimation unit 14 estimates the hand-over time to be shorter than that in a case where the driver is looking aside. Looking aside means that the face of the driver is facing the direction other than the front direction of the vehicle V.

The case where the hand-over time estimation unit 14 estimates the hand-over time based on the driving posture of the driver recognized by the driver state recognition unit 13 will be described. For example, in a case of the posture of the driver gripping the steering wheel, the driving state can be returned to the manual driving within a shorter time than in a case where the driver is not gripping the steering wheel. Therefore, for example, in a case of the posture of the driver gripping the steering wheel, the hand-over time estimation unit 14 estimates the hand-over time to be shorter than that in a case where the driver is not gripping the steering wheel. In addition, for example, in a case of the posture of the driver poised to be able to depress the accelerator pedal or the brake pedal immediately, the driving state can be returned to the manual driving within a shorter time than in a case where the posture of the driver is not poised to be able to depress the accelerator pedal or the brake pedal immediately. Therefore, for example, in a case of the posture of the driver poised to be able to depress the accelerator pedal or the brake pedal immediately, the hand-over time estimation unit 14 estimates the hand-over time to be shorter than that in a case where the posture of the driver is not poised to be able to depress the accelerator pedal or the brake pedal immediately. For example, in a case where the driver is not in the cross-legged posture, the driving state can be returned to the manual driving within a shorter time than in a case where the driver is in the cross-legged posture. Therefore, for example, in a case where the driver is not in a cross-legged posture, the hand-over time estimation unit 14 estimates the hand-over time to be shorter than that in a case where the driver is in the cross-legged posture.

The case where the hand-over time estimation unit 14 estimates the hand-over time based on the awakening degree of the driver recognized by the driver state recognition unit 13 will be described. For example, in a case where the awakening degree of the driver is high, the driving state can be returned to the manual driving within a shorter time than in a case where the awakening degree is low. Therefore, for example, in a case where the awakening degree of the driver is high, the hand-over time estimation unit 14 estimates the hand-over time to be shorter than that in a case where awakening degree is low.

The case where the hand-over time estimation unit 14 estimates the hand-over time based on the degree of tiredness of the driver recognized by the driver state recognition unit 13 will be described. For example, in a case where the degree of tiredness of the driver is low, the driving state can be returned to the manual driving within a shorter time than in a case where the degree of tiredness is high. Therefore, in a case where the degree of tiredness of the driver is low, the hand-over time estimation unit 14 estimates the hand-over time to be shorter than that in a case where degree of tiredness is high.

The system margin time estimation unit 15 estimates the system margin time. The system margin time means a time taken for the travel control unit 12 to stop the control of the travelling of the vehicle V. That is, in a case where the driving state of the vehicle V is the autonomous driving, the system margin time is a time from the current time to the time for the driving state of the vehicle V to be switched to the manual driving. In a case of calculating the system margin time, “the driving state to be switched to the manual driving” means that the autonomous driving is stopped and the driving state is switched to the manual driving because it becomes that the travel control unit 12 cannot normally continue the autonomous driving. That is, the system margin time is the time from the current time to the time for the driving state of the vehicle V to be switched to the manual driving state from the autonomous driving state without the driver's operation. As a case of switching the driving state to the manual driving without the driver's operation of releasing the autonomous driving, a case where the lane lines of the travel lane in which the vehicle V travels cannot be detected can be exemplified.

The system margin time estimation unit 15 estimates the system margin time based on the detection accuracy of the lane lines calculated by the lane recognition unit 11. In a case where the detection accuracy of the lane lines is low, the system margin time estimation unit 15 estimates the system margin time to be shorter than in a case where the detection accuracy of the lane lines is high.

The system margin time estimation unit 15 may estimate the system margin time while considering the situations of the surrounding vehicles travelling the surroundings of the vehicle V in addition to the detection accuracy of the lane lines. For example, the vehicle-to vehicle distance between the vehicle V and a preceding vehicle that travels in front of the vehicle V and the presence or absence of a side vehicle that travels on the side of the vehicle V are the situations of the surrounding vehicles. The system margin time estimation unit 15 can recognize the vehicle-to vehicle distance to the preceding vehicle and the presence or absence of the side vehicle that travels on the side of the vehicle V based on, for example, the result of detection from the external sensor 1.

For example, in a case where the vehicle-to vehicle distance between the vehicle V and the preceding vehicle is short, the system margin time estimation unit 15 estimates the system margin time to be shorter than in a case where the vehicle-to vehicle distance is long. For example, in a case where a side vehicle travelling on the side of the vehicle V is present, the system margin time estimation unit 15 estimates the system margin time to be shorter than in a case where a side vehicle is not present.

The system margin time estimation unit 15 may estimate the system margin time while considering a travel environment around the vehicle V in addition to the detection accuracy of the lane lines. For example, a degree of a complexity of the road on which the vehicle V travels, a radius of a curve, a weather, and time are the travel environment around the vehicle V. The degree of the complexity of the road is determined based on whether or not a merging or a branch is present in the travel lane of the vehicle V within a predetermined range from the vehicle V. For example, in a case where the merging or a branch is present in the travel lane of the vehicle V within a predetermined range from the vehicle V, the degree of the complexity is higher than in a case where the merging or a branch is not present in the travel lane of the vehicle V within a predetermined range from the vehicle V. The system margin time estimation unit 15 can recognize the degree of the complexity of the road on which the vehicle V travels and the radius of a curve based on, for example, the map information included in the map database 4. The system margin time estimation unit 15 may acquire the weather from, for example, a computer in a facility such as an information processing center capable of communicating with the vehicle V.

In a case where the degree of the complexity of the road is high, the system margin time estimation unit 15 estimates the system margin time to be shorter than in a case where the degree of complexity is low. For example, in a case where the radius of the curve is small, the system margin time estimation unit 15 estimates the system margin time to be shorter than in a case where the radius of the curve is large. For example, in a case where the weather is rainy or snowy, the system margin time estimation unit 15 estimates the system margin time to be shorter than in a case where the weather is sunny. For example, in a case where the time is a night time, the system margin time estimation unit 15 estimates the system margin time to be shorter than in a case where the time is a day time.

The autonomous driving margin time calculation unit 16 calculates the autonomous driving margin time. The autonomous driving margin time is calculated by subtracting the hand-over time estimated by the hand-over time estimation unit 14 from the system margin time estimated by the system margin time estimation unit 15. For example, a case where the autonomous driving margin time is long means that the driving state of the vehicle V is in a state in which there is a time margin when the driving state is switched to the manual driving from the autonomous driving. For example, a case where the autonomous driving margin time is short means that the driving state of the vehicle V is in a state in which there is a small time margin when the driving state is switched to the manual driving from the autonomous driving.

The HMI control unit 17 displays the system margin time estimated by the system margin time estimation unit 15 and the hand-over time estimated by the hand-over time estimation unit 14 on the display unit 7a. Specifically, the HMI control unit 17 displays the system margin time and the hand-over time on the display unit 7a such that the driver can recognize the length relation therebetween.

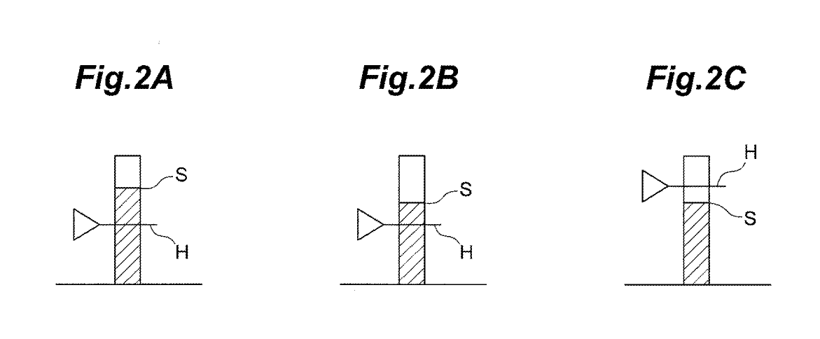

For example, the HMI control unit 17 illustrates the system margin time S by bar graphs and illustrates the hand-over time H by crossbars as the display image examples on the display unit 7a illustrated in FIG. 2A to FIG. 2C. The graphs represents that the system margin time S increases as the length of the bar becomes long (extends upward). The graphs represent that the hand-over time H increases as the height of the cross bar becomes high. By displaying the system margin time S and the hand-over time H on the same screen of the display unit 7a, the driver can easily recognize the length relation between the system margin time and the hand-over time.

Here, it is preferable that the system margin time S is longer than the hand-over time H by equal to or greater than an attention threshold value set in advance. The display image example displayed on the display unit 7a illustrated in FIG. 2A illustrates a state in which the system margin time S is longer than the hand-over time H by equal to or greater than the attention threshold value. In the state illustrated in FIG. 2A, since the system margin time S is longer than the hand-over time H by equal to or greater than the attention threshold value, the driving state of the vehicle V is in a state in which there is a time margin when the driving state is switched to the manual driving from the autonomous driving.

The display image example displayed on the display unit 7a illustrated in FIG. 2B illustrates a state in which the system margin time S is longer than the hand-over time H and a difference between the system margin time S and the hand-over time H is smaller than the attention threshold value. In the state illustrated in FIG. 2B, since the difference between the system margin time S and the hand-over time H is smaller than the attention threshold value, the driving state of the vehicle V is in a state in which there is a small time margin when the driving state is switched to the manual driving from the autonomous driving.

The display image example displayed on the display unit 7a illustrated in FIG. 2C illustrates a state in which the system margin time S is shorter than the hand-over time H. In the state illustrated in FIG. 2C, since the system margin time S is shorter than the hand-over time H, the driving state of the vehicle V is in a state in which there is no time margin when the driving state is switched to the manual driving from the autonomous driving.

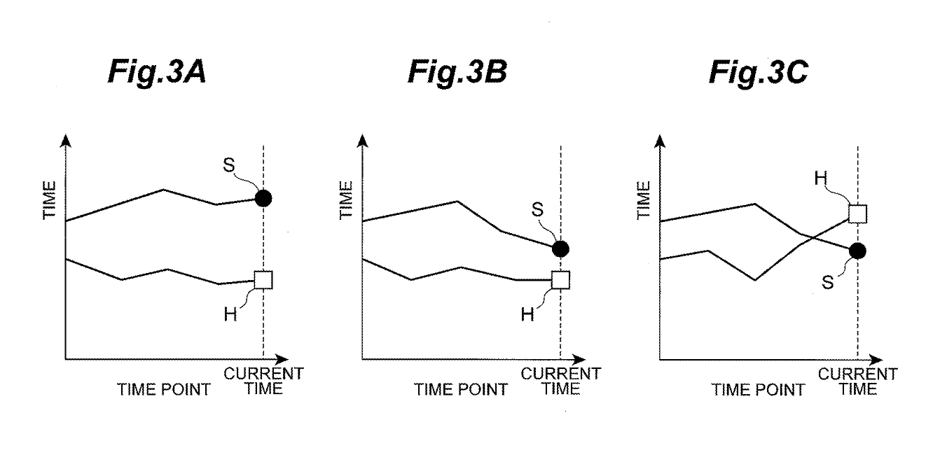

As another example of displaying the system margin time S and the hand-over time H, for example, the HMI control unit 17 may illustrate aspects of the changes of the system margin time S and the hand-over time H by line graphs as the display image examples on the display unit 7a illustrated in FIG. 3A to FIG. 3C. In the state illustrated in FIG. 3A, similarly to the state illustrated in FIG. 2A, the driving state of the vehicle V is in a state in which there is a time margin when the driving state is switched to the manual driving from the autonomous driving. In the state illustrated in FIG. 3B, similarly to the state illustrated in FIG. 2B, the driving state of the vehicle V is in a state in which there is a small time margin when the driving state is switched to the manual driving from the autonomous driving. In the state illustrated in FIG. 3C, similarly to the state illustrated in FIG. 2C, the driving state of the vehicle V is in a state in which there is no time margin when the driving state is switched to the manual driving from the autonomous driving.

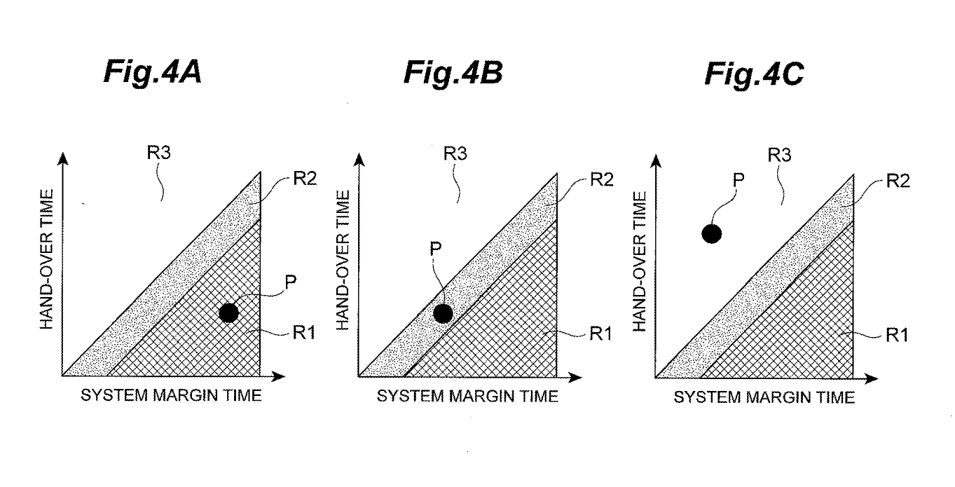

As still another example of displaying the system margin time S and the hand-over time H, for example, the HMI control unit 17 may illustrate the system margin time S and the hand-over time H at position of points P on 2D maps as the display image examples on the display unit 7a illustrated in FIG. 4A to FIG. 4C. In the 2D maps here, for example, the horizontal axis corresponds to the system margin time and the vertical axis corresponds to the hand-over time.

In the state illustrated in FIG. 4A, the point P positions in a region R1 (a region denoted by cross-hatching) on the 2D map. In the state illustrated in FIG. 4A, similarly to the state illustrated in FIG. 2A, the driving state of the vehicle V is in a state in which there is a time margin when the driving state is switched to the manual driving from the autonomous driving. In the state illustrated in FIG. 4B, the point P positions in a region R2 (a region denoted by dots) on the 2D map. In the state illustrated in FIG. 4B, similarly to the state illustrated in FIG. 2B, the driving state of the vehicle V is in a state in which there is a small time margin when the driving state is switched to the manual driving from the autonomous driving. In the state illustrated in FIG. 4C, the point P positions in a region R3 (a region denoted by neither cross-hatching nor dots) on the 2D map. In the state illustrated in FIG. 4C, similarly to the state illustrated in FIG. 2C, the driving state of the vehicle V is in a state in which there is no time margin when the driving state is switched to the manual driving from the autonomous driving.

In addition, in a case where the autonomous driving margin time is shorter than 0 (zero), since the travelling state of the vehicle V is switched to the manual driving by the travel control unit 12, the Mg control unit 17 performs a warning display indicating that the driving state is switched to the manual driving. As described using FIG. 2C and the like, the case where the autonomous driving margin time is shorter than 0 (zero) is a state in which there is no time margin when the driving state of the vehicle V is switched to the manual driving from the autonomous driving. For example, as the warning display, the HMI control unit 17 may display letters, icons or the like on the display unit 7a for urging the driver to grasp the steering wheel.

In addition, in a case where the autonomous driving margin time is equal to or longer than 0 (zero) and shorter than the attention threshold value, the HMI control unit 17 performs an attention display. The case where the autonomous driving margin time is equal to or longer than 0 (zero) and shorter than the attention threshold value is a state in which there is a small time margin when driving state of the vehicle V is switched to the manual driving from the autonomous driving as described above using FIG. 2B and the like. The attention display is a display to cause the driver to recognize that there is a small time margin when driving state of the vehicle V is switched to the manual driving from the autonomous driving. For example, as the attention display, the HMI control unit 17 may display letters or icons indicating that there is a small time margin when driving state of the vehicle V is switched to the manual driving from the autonomous driving on the display unit 7a.

Instead of or in addition to the warning display, the HMI control unit 17 may cause the driver to recognize the state in which there is no time margin when driving state of the vehicle V is switched to the manual driving from the autonomous driving using at least any of a sound, a vibration, or a lighting of a lamp. In the case of recognizing using the sound, the HMI control unit 17 may output a voice indicating the state in which there is no time margin when driving state of the vehicle V is switched to the manual driving from the autonomous driving from the sound output unit 7b. In the case of recognizing using the vibration, the HMI control unit 17 may cause the driver to recognize the state in which there is no time margin when driving state of the vehicle V is switched to the manual driving from the autonomous driving by causing the vibration generation unit 7c to generate the vibration. In the case of recognizing using the lighting of the lamp, the HMI control unit 17 may cause the driver to recognize the state in which there is no time margin when driving state of the vehicle V is switched to the manual driving from the autonomous driving by causing the lamp to light or to change the color of the light. In the case of the attention display, similarly to the warning display, instead of or in addition to the attention display, the HMI control unit 17 may cause the driver to recognize the state in which there is small time margin when driving state of the vehicle V is switched to the manual driving from the autonomous driving using at least one of a sound, a vibration, or a lighting of a lamp.

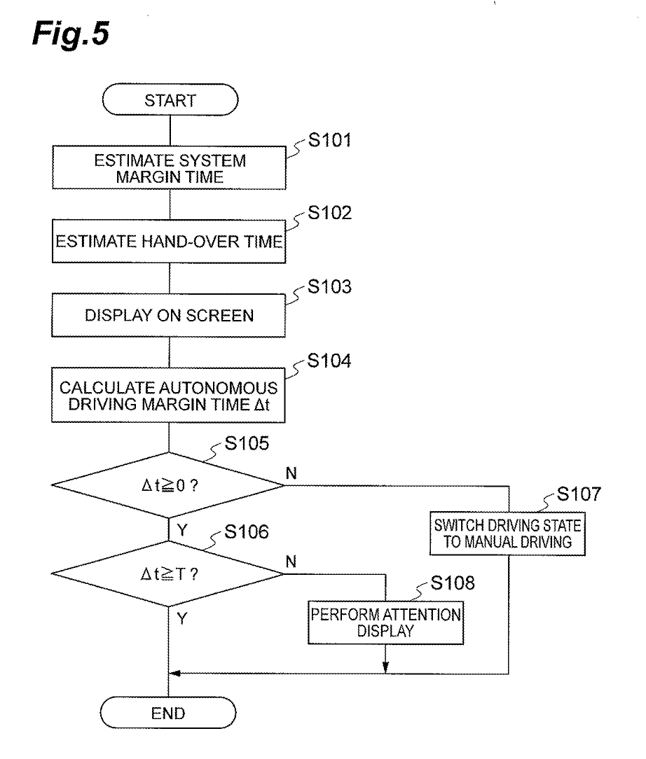

Next, flows of processing for displaying the system margin time and the hand-over time and processing for performing the warning display or the like will be described. Processing tasks in a flow chart illustrated in FIG. 5 are executed by the ECU 10 in a case where, for example, the autonomous driving of the vehicle V is started by the travel control unit 12. In a case where the processing in the flow chart arrives at END, the ECU 10 repeats again the processing from START. Alternatively, the ECU 10 may repeatedly perform the processing from START at a predetermined time interval. In a case of repeatedly performing the processing in the predetermined time interval, when newly starting the processing from START, the ECU 10 ends the previous processing even though the previous processing does not arrive at END (even during the processing). In addition, in a case where the autonomous driving of the vehicle V ends, the ECU 10 ends the processing in the flowchart even during the processing.

As illustrated in FIG. 5, the system margin time estimation unit 15 estimates the system margin time based on the detection accuracy of the lane lines calculated by the lane recognition unit 11 (S101). The hand-over time estimation unit 14 estimates the hand-over time based on the state of the driver recognized by the driver state recognition unit 13 (S102). The HMI control unit 17 displays the estimated system margin time and the hand-over time on the display unit 7a (S103).

The autonomous driving margin time calculation unit 16 calculates the autonomous driving margin time Δt based on the system margin time and the hand-over time (S104). The HMI control unit 17 determines whether or not the autonomous driving margin time Δt is equal to or longer than 0 (zero) (S105). This determination may be performed by another unit other than the HMI control unit 17. In this case, the HMI control unit 17 may acquire only the determination result. In a case where the autonomous driving margin time Δt is equal to or longer than 0 (zero) (YES in S105), the HMI control unit 17 determines whether or not the autonomous driving margin time Δt is equal to or longer than the attention threshold value T (S106). In a case where the autonomous driving margin time Δt is equal to or longer than the attention threshold value T (YES in S106), the ECU 10 ends the current processing and starts the processing again from the new START.

In a case where the autonomous driving margin time Δt is not equal to or longer than 0 (zero) (NO in S105), the HMI control unit 17 performs the warning display. After the warning display, the travel control unit 12 switches the travelling state of the vehicle V to the manual driving from the autonomous driving (S107). After the travelling state of the vehicle V is switched to the autonomous driving, the ECU 10 ends the current processing and starts the processing again from the new START.

In a case where the autonomous driving margin time Δt is not equal to or longer than the attention threshold value T (NO in S106), the HMI control unit 17 performs the attention display (S108). After the attention display, the ECU 10 ends the current processing and starts the processing again from the new START.

The present embodiment is configured as described above. The system margin time estimation unit 15 estimates the system margin time based on the accuracy of detecting the lane lines by the lane recognition unit 11. The hand-over time estimation unit 14 estimates the hand-over time based on the state of the driver of the vehicle V. The HMI control unit 17 displays the system margin time and the hand-over time on the display unit 7a. In this way, the driver of the vehicle V can recognize the system margin time and the hand-over time by looking at the display unit 7a. As described above, by the driver recognizing the system margin time and the hand-over time, it is possible for the driver to maintain the awareness for the driving operation such as being aware of shortening the hand-over time.

The HMI control unit 17 may perform a display other than the display examples illustrated in FIG. 2A to FIG. 2C, FIG. 3A to FIG. 3C, and FIG. 4A to FIG. 4C as long as the driver can recognize the length relation between the system margin time and the hand-over time. In addition, for example, it is not essential for the hand-over time estimation unit 14 to estimate the hand-over time based on at least any of the direction of the driver's line of sight, the driving posture of the driver, the awakening degree of the driver, and the degree of tiredness of the driver. The hand-over time estimation unit 14 may estimate the hand-over time based on a state other than the states described above as the driver's state.

In addition, for example, the HMI control unit 17 may perform a notification for notifying the driver of the length of the autonomous driving margin time estimated by the autonomous driving margin time calculation unit 16. For example, the HMI control unit 17 may change the method of the notification according to three cases such as a case of a long time state in which the autonomous driving margin time is long, a case of a medium time state in which the autonomous driving margin time is shorter than that in the long time state, and a case of a short time state in which the autonomous driving margin time is shorter than that in the medium time state. This notification may be performed by displaying the letters or icons on the display unit 7a according to the state of the autonomous driving margin time. In addition, this notification may be performed by outputting the voice or a signal sound from the sound output unit 7b according to the state of the autonomous driving margin time. In addition, this notification may be performed by causing the vibration generation unit 7c to generate the vibration according to the state of the autonomous driving margin time. In addition, this notification may be performed by changing the state of lighting the lamp 7d and changing the color of the light of the lamp 7d according to the state of the autonomous driving margin time. In this way, by changing the method of the notification, it is possible for the driver to recognize the state of the autonomous driving margin time.

The vehicle control apparatus 100 may perform an autonomous driving in which, for example, a lane keeping assist (LKA) and a lane trace control (LTC) are executed at the same time other than performing the autonomous driving by generating the travel plan as described above. The LKA is a control for autonomously performing the steering of a vehicle such that the vehicle does not depart from the travel lane recognized by the lane recognition unit 11. In the LKA, for example, even in a case where the driver does not perform the steering operation, the steering of the vehicle is autonomously performed along the travel lane. The LTC is a control for autonomously performing the adjustment of the steering and the speed of the vehicle such that an optimal traveling line can be calculated based on the lane lines and a preceding vehicle detected using the camera, the radar and the like, and then, the vehicle can travel along the calculated traveling line. In addition, the vehicle control apparatus 100 may perform an autonomous driving other than the autonomous driving in which the travel plan described above is generated and the control is performed and the autonomous driving in which the LKA and the LTC are performed at the same time as long as the travelling in the autonomous driving is controlled based on the travel lane of the vehicle V.

What is claimed is:

1. A vehicle control apparatus configured to be mounted on a vehicle in which a driving state can be switched between autonomous driving and manual driving, the apparatus comprising:
a lane recognition unit configured to detect lane lines on a road on which the vehicle travels based on image information from a camera and to recognize a travel lane of the vehicle based on a result of detecting the lane lines;
a travel control unit configured to control the travelling of the vehicle such that the driving state of the vehicle becomes autonomous driving based on the travel lane recognized by the lane recognition unit;
a first estimation unit configured to estimate a system margin time which is a time taken for the control of the travelling of the vehicle by the travel control unit to stop, based on the accuracy of detecting the lane lines by the lane recognition unit;
a second estimation unit configured to estimate a hand-over time which is a time taken for the driving state of the vehicle to return to manual driving by the driver from the autonomous driving state, based on a state of the driver of the vehicle; and
a display control unit configured to display the system margin time and the hand-over time on a display unit.
